(19) United States
(12) Patent Application Publication
(10) Pub. No.: US 2015/0074716 A1
(43) Pub. Date: Mar. 12, 2015

(54) Method And Apparatus For Advertising In A Social, Distributed Content Viewing System

(71) Applicant: THOMSON LICENSING, Issy de Moulineaux (FR)

(72) Inventors: William Gibbens Redmann, Glendale, CA (US); Mark J Huber, Burbank, CA (US); Mark Leroy Walker, Castaic, CA (US)

(21) Appl. No.: 14/389,916

(22) PCT Filed: Apr. 30, 2012
(86) PCT No.: PCT/US12/35749

§ 371 Date: Oct. 1, 2014

(51) Int. Cl. H04N 21/45; H04N 21/4788; H04N 21/25; H04N 21/466; H04N 21/442; H04N 21/234; H04N 21/458; H04N 21/81; H04N 21/4223; G06Q 50/00; H04N 21/475

(52) U.S. Cl. CPC H04N 21/4532; G06Q 50/01; H04N 21/4788; H04N 21/251; H04N 21/4668; H04N 21/4756; H04N 21/23424; H04N 21/458; H04N 21/812; H04N 21/4223; H04N 21/44222
USPC 725/34

(57) ABSTRACT

Selection of an advertisement by a user for playout to at least one member of an audience of distributed members commences by establishing a content recommendation from the one audience member based on the one audience member's interaction with the at least one piece of content. The content recommended by the one audience member is transmitted to the at least one other member for playout to that other member

### TECHNICAL FIELD

This invention relates to selection of content, and particularly advertisements, for viewing in a distributed audience environment.

### BACKGROUND ART

Presently, there exist systems that facilitate distributed viewing of content among members of a viewing audience while affording video and audio interaction among such audience members. Such systems bear the designation as “Telepresence Systems” and typically employ a set-top box as the control mechanism for managing both incoming and outgoing video and audio transmissions at each site. In practice, the content delivered to the audience members includes feature presentations such as movies or television programs, along with associated advertising. Typically, no differentiation exists between the advertising and the feature presentation that collectively comprise the content. In other words, the advertising has no markings or other indicia that specifically differentiates it from the feature presentation. Thus, when one or more different individuals view the same content, they typically view the same advertising.

Some providers vary the advertising provided in streamed content in accordance with who views the content and when they do so. For example, a particular show streamed from Hulu.com, a web site operated by Hulu, LLC, Los Angeles, Calif., a commercial video streaming company, might contain certain advertising if viewed one day but different advertising when viewing the content on a different day. Similarly, some streaming video systems track advertisements shown to a particular viewer and vary advertisement selection based on the history of advertisements previously shown to that viewer. Sophisticated systems can also take account of demographic or location information about a viewer. Indeed, some systems actually consult viewers and select advertising based on viewer-designated preferences to provide the most pertinent, interesting, or valuable advertisements.

Systems such as those described above which vary advertising typically do not operate well in a distributed audience environment where viewers reside at different locations. Likewise, advertising systems driven by demographics would likely not find application with a distributed audience whose demographics can vary widely depending on the audience members.

Presently, no known systems exist that exploits individual viewers of a distributed audience as a mechanism for selecting advertisements for presentation to other viewers in the audience.

### BRIEF SUMMARY OF THE INVENTION

Briefly, in accordance with a preferred embodiment of the present principles, selection of an advertisement by a user for playout to at least one member of an audience of distributed members commences by establishing a content recommendation from the one audience member based on the one audience member's interaction with the at least one piece of content. The content recommended by the one audience member is transmitted to the at least one other member for playout to that other member.

### BRIEF DESCRIPTION OF THE DRAWINGS

FIG. 1 depicts a block diagram of a distributed audience telepresence system that receives content from a head end for simultaneous viewing at each of a plurality of stations;

FIG. 2 depicts a sequence of screen displays generated by the telepresence system of FIG. 1 in connection with the playout of a selected advertisement;

FIGS. 3A & 3B each illustrate a sequence of events associated with identification of candidate advertisements for recommendation to other distributed audience members;

FIG. 4 depicts an exemplary schema of a portion of a database within the telepresence system of FIG. 1 for storing information associated with the audience members and sites served by the telepresence system of FIG. 1;

FIG. 5 depicts an exemplary schema of another portion of the database of FIG. 1 for storing programs, advertisements, sponsorships, and candidate advertisement selections;

FIG. 6 depicts a first exemplary schema of a yet another portion of the database of FIG. 1 for storing social sessions and advertisement(s) selected by one or more the distributed audience members for playout to other audience members;

FIG. 7 depicts a second exemplary schema of a yet another portion of the database of FIG. 1 for storing social sessions and advertisement(s) selected by one or more the distributed audience members for playout to other audience members;

FIG. 8 depicts, in flow chart form, a process for identifying candidate advertisement selections;

FIG. 9 depicts an exemplary user interface for selecting a candidate advertisement;

FIG. 10 depicts an exemplary user interface for arranging a social viewing session and for selecting one or more advertisements for that viewing session;

FIG. 11 depicts, in flow chart form, a process for selecting one or more advertisements for a social viewing session; and,

FIG. 12 depicts an exemplary presentation sequence of screen displays associated with advertisement selection with and without attribution of the audience member who recommended the advertisement.

### DETAILED DESCRIPTION

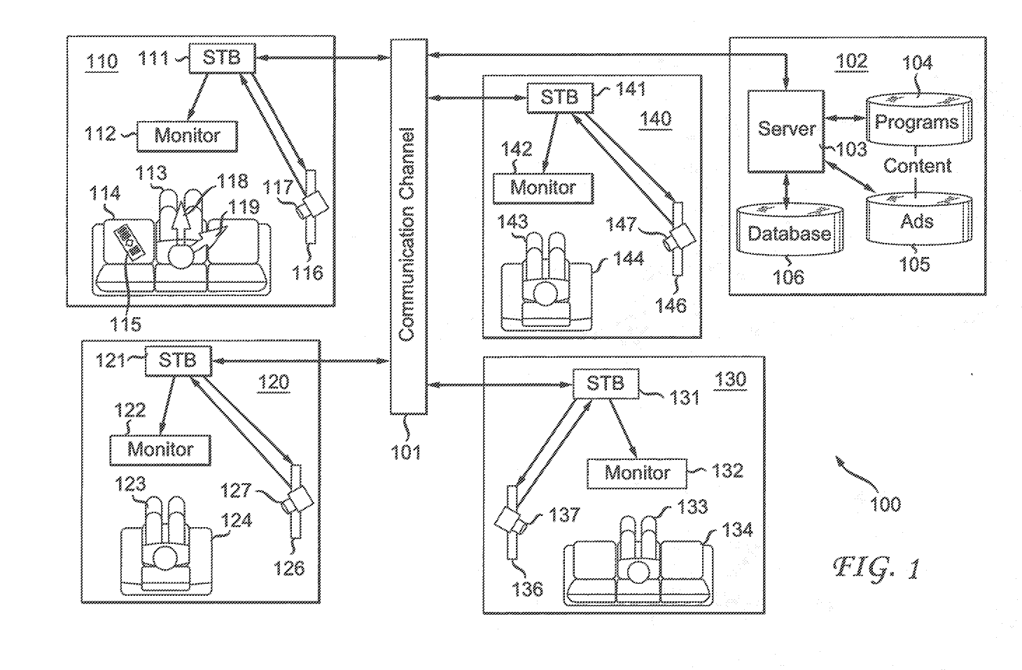

FIG. 1 depicts a block schematic diagram of a telepresence system 100 deployed to service four sites 110, 120, 130, and 140, respectively. Although the exemplary embodiment of FIG. 1 only depicts four sites 110, 120, 130 and 140, the telepresence system 100 can service a larger or smaller number of sites without departing from the scope of the present principles. Each of sites 110, 120, 130, and 140 accommodates an associated one of members 113, 123, 133, and 143, respectively, who collectively constitute a distributed audience. (The term “audience member” is synonymous with the terms “participant,” “user,” and “viewer” as used hereinafter.). At each of the sites 110, 120, 130, and 140, each of audience members 113, 123, 133, and 143, respectively, watches a corresponding one of content monitors 112, 122, 132, and 142, respectively, while the audience member remains situated on an associated one of couches or chairs 114, 124, 134, and 144, respectively.

At each of sites 110, 120, 130, and 140, a corresponding one of set-top boxes (STBs) 111, 121, 131, and 141, serves as the control mechanism for managing both incoming and outgoing video and audio transmissions to and from, each site as described hereinafter. Further, each of the STB controls the reception of content at its associated site from a head end 102. Each STB connects via a communication channel 101 to a network (not shown) such as a cable television service network or a broadband network (e.g., the Internet). The network connection among the STBs 111, 121, 131, and 141 allows the STBs to receive and send video and audio information to each other.

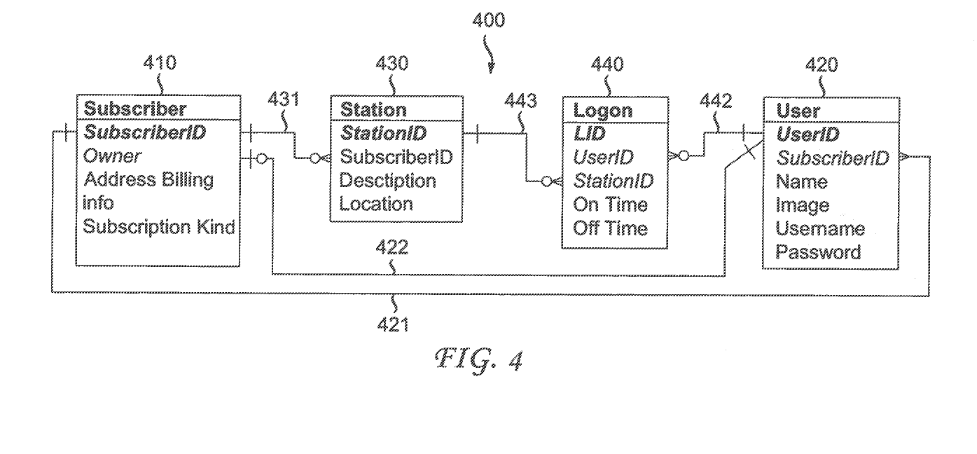

In the exemplary embodiment of FIG. 1, the majority of the content (comprising audio and video information) received by each of STBs 111, 121, 131, and 141 for playout and display on the content monitors 112, 122, 132, and 142, respectively, originates from the head-end 102 coupled to the communication channel 101. In practice, the head end includes a server 103 coupled to a pair of databases 103 and 104, which store feature presentations (movies and programs for example) and advertisements, respectively. The server 103 also communicates with a database 106 that stores information for tracking sites, audience members, sessions, programs, and advertisements as well as the relationships among them, as described below in conjunction with FIGS. 4-7. While the exemplary embodiment of FIG. 1 depicts the head end 102 as comprising three separate databases 104, 105, and 106, a single database (not shown) could store the information residing in each of these separate databases.

The sites 110, 120, 130, and 140 include video captures devices, illustratively depicted by telepresence camera 117, 127, 137, and 147, respectively, coupled to the STBs 111, 121, 131, and 141, respectively. In practice, each of the telepresence cameras 117, 127, 137, and 147 at a given site captures the image of a corresponding one of the audience members 113, 123, 133, and 143, respectively. Note that one or more sites could include more than one audience member. Thus, the telepresence camera at the site would capture the image of all audience members at that site. As depicted in FIG. 1, each of the telepresence cameras 117, 127, 137 and 147 resides on top of a corresponding one of telepresence monitors 116, 126, 136, and 146, respectively. However, the telepresence camera need not reside on top of a corresponding telepresence monitor but could reside elsewhere. In practice, each telepresence monitor displays the image of the audience members at the other sites, whereas each content monitor displays content (feature presentations and advertising) to the audience member(s) at that site.

For ease of discussion, the term “local” will refer to the audience member at a given site whose image undergoes capture by the telepresence camera at that site for display at another site. Conversely, the term “remote” refers to an audience member at another site whose image undergoes display for observation by the local audience member via his or her telepresence monitor.

Still referring to FIG. 1, each of the telepresence monitors 116, 126, 136 and 146, typically resides at a right angle to a corresponding one of the content monitors 112, 122, 132 and 142, respectively. Thus, when each audience member faces in a first direction, such as the audience member 113 facing in the direction 118, then that audience member will look directly at his or her content monitor (e.g., the content monitor 112 at the site 110). While the audience member 113 directly faces his or her content monitor 112, the corresponding telepresence camera 117 at the site 110 will capture a side view of that audience member. However, when the audience 113 member faces the telepresence monitor, as exemplified by the audience member 113 facing in the direction 119 to look almost directly at the telepresence monitor 116, then the associated telepresence camera 117 will generally capture a front view of that audience member.

At some sites (e.g., the site 130), the telepresence monitor and telepresence camera lie to the left of the content monitor. At other sites (e.g., the sites 110, 120, and 140), the telepresence monitor and telepresence camera lies to the right of the content monitor. The STB at each site will exchange such information with the STBs at other sites about the facing (i.e., the orientation) of the audience member at that site relative to that audience member's telepresence monitor (right or left). Alternatively, the STBs can interact with each other by assuming a predetermined facing of their corresponding audience members when transmitting and receiving video streams.

As discussed, the STB at each site acquires the image of its corresponding audience member via its associated telepresence camera. However, each STB could acquire the image of its corresponding audience member by other means. For example, the STB could capture the image of its corresponding audience member via an image capture device comprising part of a laptop computer, web cam, or cell phone, for example, in communication with the STB though a wired or wireless connection.

The audience member at each site can control his or her associated STB through a remote control, such as the remote control 115 associated with the STB 111 at site 110. Using the remote control 115, the audience member can perform various operations, including but not limited to selecting content for personal viewing. In accordance with a preferred embodiment of the present principles, the audience member can also use his or her remote control to select advertisements for recommendation to one or more other audience members in the manner discussed hereinafter.

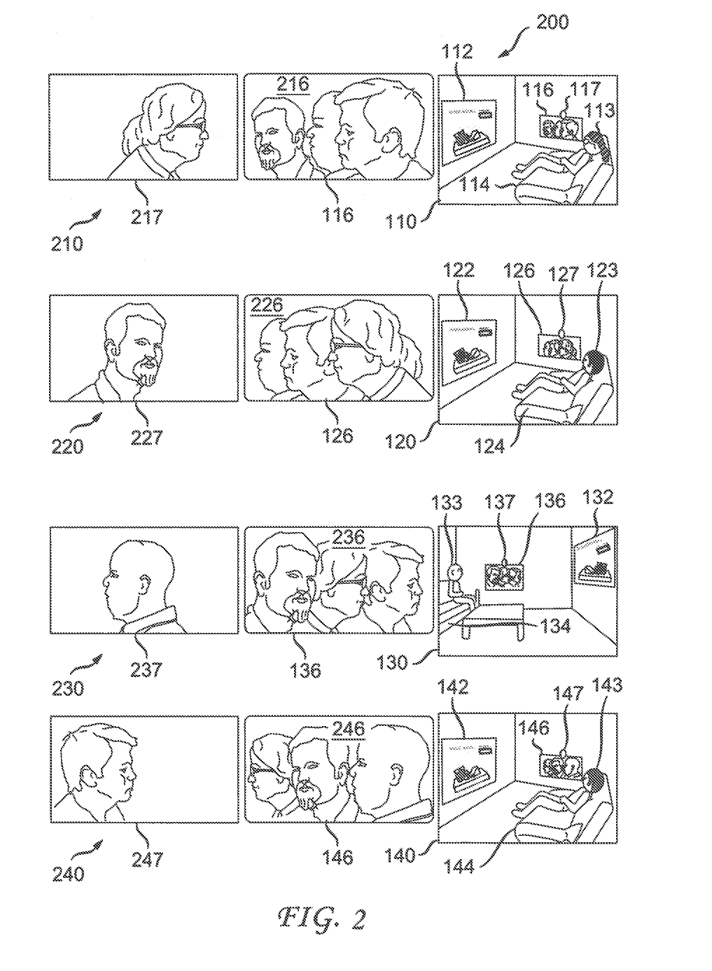

FIG. 2 illustrates a collection 200 of “situations” 210, 220, 230, and 240 associated with the sites 110, 120, 130, and 140, respectively. Each of situations 210, 220, 230, and 240 comprises images pairs 216-217, 226-227, 236-237, and 246-247, respectively. As discussed hereinafter, the first image 216, 226, 236, and 246 of each of the image pairs represents the images displayed on the corresponding telepresence monitor, whereas, the images 217, 227, 237 and 247 represent images captured by the corresponding telepresence camera. Thus, the first image 216 of the situation 210 represents a screen shot of the image displayed on the telepresence monitor 116 and depicts a composite view of the audience members at the other sites (e.g., audience members 123, 133, and 143, respectively, at sites 120, 130, and 140, respectively). The second image 217 of the situation 210, represents the image of the local audience member 113 at the site 110 captured by the corresponding telepresence camera device 117 or other image capture device at that site (not shown). The same relationship as described for the image pair 216-217 applies to the image pairs 226-227, 236-237, and 246-247.

In the illustrated embodiment of FIG. 2, each of the audience members 113, 133, and 143 looks directly at his or her associated content monitors, 112, 132, and 142, respectively. For that reason, in each of images 216, 236, and 246, the audience members 113, 133, and 143, respectively, appear in profile. For purpose of illustration, the audience member 123 has his or her head turned towards the associated telepresence monitor 126 so the image of the audience member 123 appears in each of images 216, 236, and 246 as obliquely facing the screen.

The images 217, 227, 237, and 247, corresponding to the images of the local audience members 113, 123, 133 and 143, respectively, will undergo flipping or not prior to display on the remote telepresence monitors depending on whether the facings of the local and remote audience members coincide. For example, the image 227 corresponding to the image of the audience member 123 at site 120, will undergo horizontal flipping prior to display on the remote telepresence monitors 116 and 146 because the audience members at sites 110 and 120 and at sites 120 and 140 face the same way. However, the image 227 will not undergo flipping prior to display on the telepresence monitor 136 because the audience member 133 appearing in the image 227 has an opposite facing compared to the audience member 123 at the site 120. In the example depicted in FIG. 2, the audience member 133 at the site 130 faces opposite to the audience members at the other sites. Therefore, the 137 image of the audience member 137 of FIG. 2 237 will not undergo flipping when displayed on the remote telepresence monitors 116, 126, 146, as part of the composite images 216, 226, 246, respectively, displaying all of the distributed audience members. In order to create the images 216, 226, 236, and 246, each audience member's head must be isolated from the background in the images 217, 227, 237, and 247, respectively.

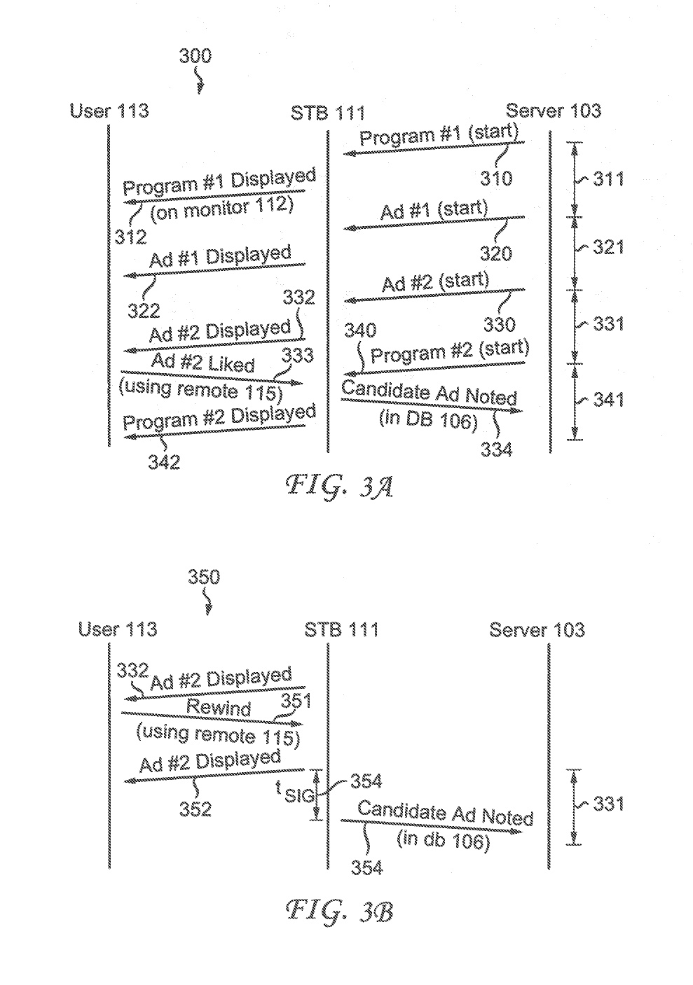

FIG. 3A illustrates a first exemplary series 300 of events associated with identification of candidate advertisements for recommendation by one audience member (e.g., the audience member 113 at the site 110) to other distributed audience members. As will become better understood hereinafter, the events comprising the series 300 of FIG. 3A occur without the participation of the audience members other than the audience member 113 at site 110 of FIGS. 1 and 2 making the advertisement recommendation. The series 300 of FIG. 3A commences with delivery of a selected program (identified as program #1) from the server 103 to the STB 111 at the site 110 of FIGS. 1 and 2 during step 310 of FIG. 3A. Thereafter, the STB 111 generates the display of the program on the content monitor 122 for observation by the audience member 113. Such display can occur substantially simultaneously following the delivery of the program, or after some time interval thereafter, from as little as a few milliseconds to hours or even days later. After a given interval, indicated by the interval 311 in FIG. 3A, typically, although not necessarily corresponding to the duration of the program #1, the server 103 transmits a selected advertisement (identified as advertisement #1) to the STB 111 of FIG. 1 during step 320 of FIG. 3A, whereupon the STB generates the display of the advertisement #1 on the content monitor 112 during step 322.

After another interval 321 (typically, the duration of advertisement #1), the server 103 of FIG. 1 transmits another advertisement (identified as advertisement #2) to the STB 111 during step 333 of FIG. 3A, whereupon the STB generates the display of that advertisement on the content monitor 122 of FIG. 1 during step 322 of FIG. 3A. Following an interval 331 (typically, the duration of advertisement #2), the server 103 transmits a second program (identified as program #2) to the STB 111 during step 340, whereupon the STB generates a display of that program on the content monitor 122 of FIG. 1 during step 342 of FIG. 3A

At any time during or after playout of the advertisement #2 to the audience member 113 of FIG. 1, that audience member can use his or her remote control 115 of FIG. 1 to signal the STB 111 during step 333 of FIG. 3A to indicate his or her enjoyment of that advertisement. Rather than make use of the remote control, the audience member 113 could make use of other devices in communication with the STB 11 such as the audience member's laptop computer, tablet, smart phone, or cell phone, for example. Upon receipt of an indication from the audience member 113 of his or her enjoyment of the particular advertisement, the STB 111 will communicate that information to the server 103 of FIG. 1 for forwarding to the database 106 during step 334 of FIG. 3A so that the database can record that information in the manner described hereinafter.

In practice, the audience member will indicate his or her enjoyment of the advertisement #2 when played out during step 332 rather than upon transmission of the advertisement during step 330. Nonetheless, the STB 111 of FIG. 1 will forward that information to the database 106 during step 334. As depicted in FIG. 2, execution of step 334 typically occurs during the interval 341 corresponding to the duration of program #2. Rather than store that information in the database 106, the STB 111 could record that information internally.

Note that the presentation of program #2 can occur during step 340 immediately after the presentation of the advertisement #2 during step 332. Thus, delivery of the program #2 can occur without necessarily waiting for any explicit response from the audience member during step 333 to indicate the user's enjoyment of the advertisement #2, which will trigger selection of that advertisement for later use. The time interval 341 typically corresponds to the duration of program #2.

FIG. 3B illustrates a second exemplary series 350 of events associated with identification of candidate advertisements for recommendation by an audience member to other distributed audience members. The series 350 commences with execution of step 332 during which time the STB 111 initiates the display of the second advertisement (advertisement #2) on the content monitor 112 of FIGS. 1 and 2. (The step 332 of FIG. 3B corresponds to the step 332 of FIG. 3A.) Now assume that the audience member 113 has entered a rewind command during the step 351 using either the remote control 115 of FIG. 1 or an alternative mechanism. In response to receiving such a rewind command, the STB 111 will initiate playback of all or part of the advertisement #2 during step 352. If the length of the advertisement #2 played back during 352 exceeds an interval t_{SIG} (a predetermined amount interval 354 set by policy), then the STB 111 forwards that information to the database 106 via the server 103 (both of FIG. 1). In response, the database 106 makes a record of the advertisement to allow for its selection at a subsequent time. An audience member that has replayed at least a significant portion of the advertisement #2 presumably enjoyed that advertisement enough to watch at least a portion thereof again. Thus, the audience member would likely recommend the advertisement to other audience members.

The following discussion of the database 106 of FIG. 1 assumes a virtual partition of the database into three portions 400, 500, and 600, depicted in FIGS. 4, 5 and 6, respectively, for storing information concerning users, content (programs & advertisements), and sessions, respectively. For ease of discussion, the portions 400, 500, and 600 will bear the labels “user portion,” “content portion,” and “session portion,” respectively. Those skilled in the art should appreciate that a physical partition of the database need not actually exist to implement the present principles.

Referring to FIG. 4, the user portion 400 of the database 106 comprises four tables, 410, 420, 430, and 440, respectively. The table 410, hereinafter referred to as the “Subscriber table,” contains one or more records for each subscription (or contract or account) associated with each user receiving services from the telepresence system 100 of FIG. 1. (A user constitutes someone with permission to use the telepresence system 100 of FIG. 1, and upon logging in, becomes a distributed audience member as discussed previously.)

An identifier, hereinafter referred to as “a SubscriberID” uniquely identifies each record and the user (subscriber) associated with that record. Each record in the subscriber ID table 410 identified by a corresponding SubscriberID includes the installation address and billing information, as well as an indication of the kind of channel packages or level of service to which the user subscribes.

The table 420, hereinafter referred to as “the User table” contains a record for each user of the telepresence system 100. A UserID uniquely identifies each user record in the User table 420. Each user has exactly one subscriber record, linked to the record in the Subscriber ID table 410 via a membership relationship 421. Similarly, each subscriber record in the 410 has exactly one user designated as the owner of the subscription linked through an ownership relationship 422. In some embodiments, the owner relationship 422 can designate a user having the ability to create other users with the same subscription, such as other members of the same family. Further, in some embodiments, as in this example, each user can have a formal username and password for logging into the telepresence system 100. Each user can have an informal name (e.g., a display name or nickname) that will casually identify that user to others. The User table 420 can store an image of the user for use when displaying the user's name remains a less desirable alternative. Further, the User table 420 can serve to disambiguate displays where multiple users could have the same informal names.

The table 430, hereinafter referred to as “the Station table, stores a record for each of the STBs 111, 121, 131, and 141 and/or other authorized hardware allowed to connect to, and obtain services from, the head-end 102 of FIG. 1. A StationID uniquely identifies each station record. Each station has an associated service subscription record identified by an authorization relationship 431. Each station record typically contains a description of the STB and/or authorized hardware at a given site, which can include unique identifying information (e.g., a MAC address or digital certificate). Further, each station record can include location information, such as a street address, as well as an apartment number, and/or a geocode representing latitude/longitude, which could prove useful for service calls and/or other location-related services.

The table 440, hereinafter referred to as the “Logon table,” implements a many-to-many relationship identifying which users have logged onto which stations. Each user can log into one or more stations or not log into any station at all as indicated by a user logged-on relationship 442. Thus, each station could have no users or one or more users logged on as identified by a station logged-into relationship 443. A LogonID (LID) field uniquely identifies each record in the Logon table 440. In the illustrated example of FIG. 4, each record in the Logon table 440 typically includes On-Time and Off-Time fields, for recording each time a user logs on and off. The On-Time and Off-time fields allow the telepresence system 100 to recognize those users currently logged into stations (i.e., from logon records where the Off-time field has a null value) as well as track usage by user (assuming retention of logon records for billing or other later analysis). In some embodiments, operating policies might limit a user to having a single logon at a time, in which case, the creation of a new logon record for a user could force the closeout of another logon record for the same user by noting the off time in the prior logon record upon creation of the new logon record.

The User portion 400 of database 106 of FIG. 1 can track users currently logged on to the telepresence system 100 of FIG. 1, the stations logged into by such users, and the subscriptions associated with such users. As a matter of policy, the operator of the telepresence system 100 can permit or prohibit users from logging onto stations other than those stations associated with the users' subscription. In other words, the system operator can set a policy that permits a user to log into a station (e.g., STB) at a hotel or friend's house under that user's own username, even though such stations have an association with other users. Alternatively, the system operator could restrict users to their own stations.

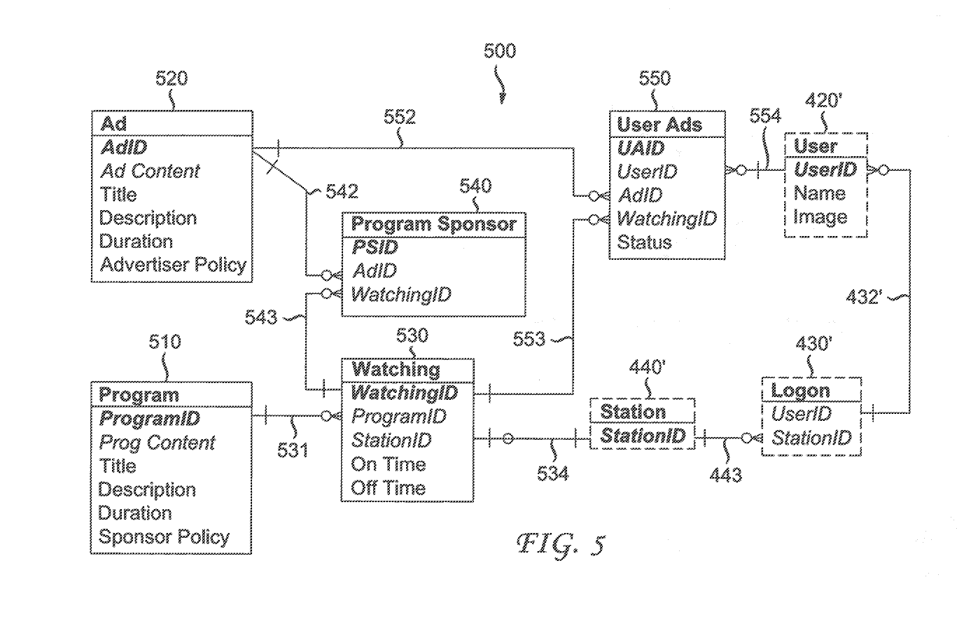

FIG. 5 depicts an exemplary embodiment of the content portion 500 of the database 106 of FIG. 1. The content portion 500 includes a set of tables 510, 520, 530, 540, and 550. The table 510, hereinafter referred to as the “Program table,” includes a record for each piece of content (e.g., a movie or television program), with each record identified by a unique identifier “ProgramID.” The Program table 510 includes a field “prog-content” that provides a reference to the corresponding program content in the content database 104 depicted in FIG. 1. The Program table 510 of FIG. 1 can include other information about the program, including a program description, duration, and sponsorship policy information. The sponsorship policy information field typically provides a list of products and/or services contained in the program, or otherwise suitable for advertisement in conjunction with that program. For example, if the program depicts the consumption of a particular brand of soft drink, the program will constitute a good match for accompanying advertisements for that same brand of soft drink. Conversely, that same program would likely constitute be a bad match for competing soft drink brands. Thus, the sponsorship policy information could include information identifying products and/or services representing a poor match for that program.

Some programs might be subject to an exclusive sponsorship agreement with a particular advertiser. Under such circumstances, information indicating such an exclusive sponsorship would reside in a sponsorship policy information field of the Program table 510. The sponsorship policy information field can also include information indicative of how often and/or for how long advertisements can interrupt the program and the allowable forms such interruptions can take. For example, the sponsorship policy can indicate whether advertisements can interrupt the program. In addition, the sponsorship policy information field can indicate a user can permissibly skip advertisements. Further, the sponsorship policy information field can indicate whether advertising crawls can overlay the screen while the program undergoes playout and precisely where in the program such advertising cannot occur (e.g., the interval encompassing the climax of a movie).

The table 520 hereinafter referred to as “Advertisement table,” shares features in common with the program table 510. The Advertisement table 520 stores a plurality of records, with each record having a unique advertising identifier (AdID) and an advertisement policy content field referencing corresponding advertisements in the advertisement content database 105 of FIG. 1. Further, the advertiser policy information field typically contains data representing the permissible number of advertisements that can accompany a given program. For example, some advertisements can include a designation that permits requests for sponsorship of content undergoing shared viewing, in accordance with one of the present principles. Conversely, other advertisements might include a designation that prevents sponsorship on request. Additional advertisement policy information can include constraints, e.g., an advertisement for a particular brand of soft drinks can include a designation as inappropriate for sponsoring programs featuring a different brand of soft drinks.

The table 530, hereinafter designated as the “Watching table,” contains a record for each program watched by each station (e.g., each STB). A unique identifier, “WatchingID,” identifies each watching record in the Watching table 530. The programID of the program undergoing playout to distributed audience member has a relationship with that audience member defined by a watched relationship 531, while the stationID of the station “tuned” to the program has a relationship with the program established by a watching relationship 543.

FIG. 5 also depicts a set of tables 420′, 430′, and 440′ in phantom. The tables 420′, 430′, and 440′ in FIG. 5 correspond to the User table 420, Logon Table 430 and Station Table 440, respectively, described previously with respect to FIG. 4. In the exemplary embodiment of FIG. 5, the records in the Watching table 530 include on-time and off-time fields to note when a particular station has tuned into and out of a program. A watching record with a null value for the Off-time field represents a station currently tuned to watch a particular program. The collection of watching records for previously watched programs, together with the station records associated with those stations tuned to such watched programs collectively yield a log useful for billing or for data mining operations.

Advertisements that undergo playout during or in temporal proximity to a program can have an association with that program and the station tuned to watch that program by the many-to-many relationship formed with the records in the Program sponsor table 540. Each record in the Program sponsor table 540 has a unique identifier PSID, associated with an advertisement by a sponsor relationship 542. The same record can also have an association with a watching record by established by a sponsor's relationship 543. Thus, if a particular advertisement plays out on a station watching a particular program, that sponsorship is noted for billing and/or or data mining purposes.

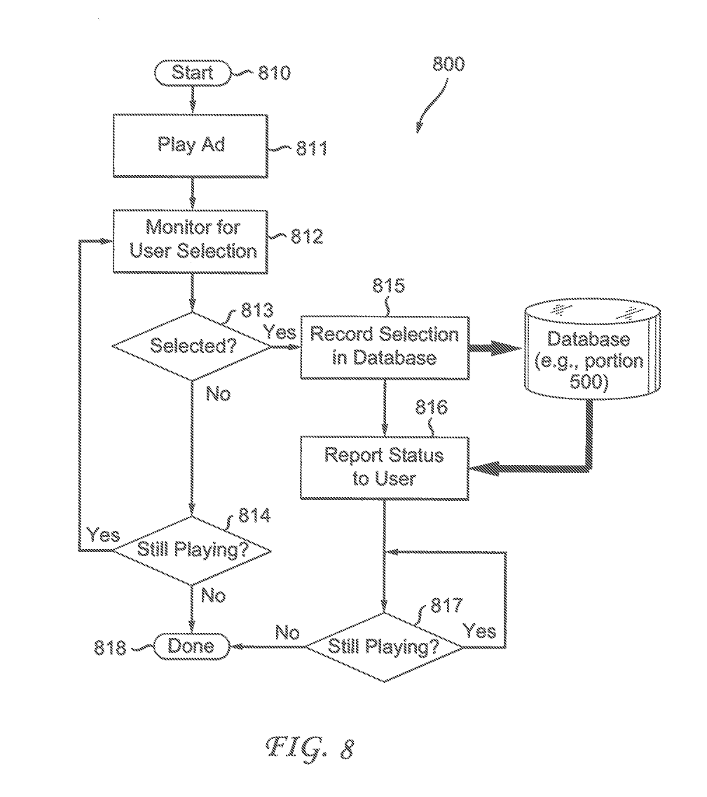

As discussed in detail hereinafter with respect to FIG. 8, a user may select an advertisement, causing collection of that advertisement and creation of a record in the Advertisements table 550 associating that advertisement with the user who selected it. Each user advertisement record in the Advertisements table 550 has a unique identifier UAID, associated with the user selecting that advertisement in accordance with a user's relationship 554. An advertisement relationship 552 serves to identify the relationship between that advertisement and the user, while a watching relationship 553 will identify the relationship n between the advertisement and the user watching it. When a user selects an advertisement 520, a check occurs of the advertiser's policy for that advertisement. Typically, the advertiser responsible for a given advertisement will establish a policy indicating whether the advertiser will permit use of the advertisement following user selection. If the advertiser's policy for an advertisement changes, the status of those advertisements associated user's selection thereof by an advertisement relationship 552 can undergo automatic updating. Even though the advertiser does not currently permit use of an advertisement to sponsor a social session, the telepresence system 100 of FIG. 1 can report to the advertiser the number of selecting users clamoring for access to that advertisement, leading to a change in policy.

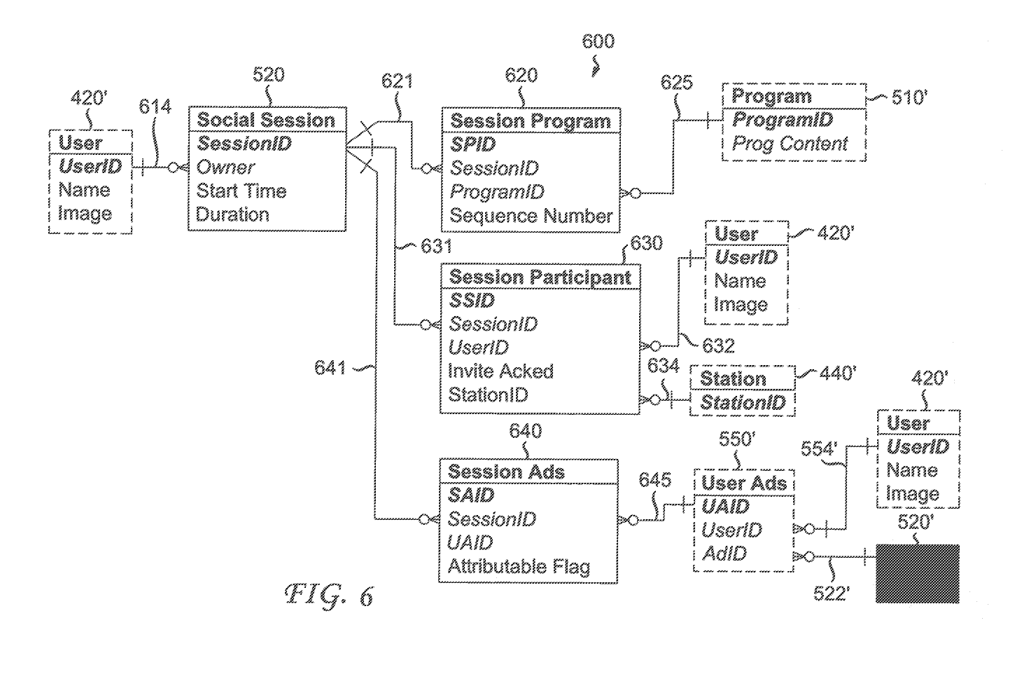

FIG. 6 depicts the Social session portion 600 of the database 106 of FIG. 1. In the exemplary embodiment, the social session portion 600 portion of the database 106 records information about each session of social television watching. Social television watching constitutes the watching of one or more programs by two or more distributed audience members. Each recorded social session has a unique SessionID in a Social session table 610 in the Social session portion 600 of the database 106. Each social session has an owner, defined by a session owner relationship 614, which allows the owner to invite or eject other audience members (or their stations) from the session. The owner could plan a session in advance, in which case the start time will correspond to some future date/time. Alternatively, the session could begin immediately, in which case the start time becomes the current time (e.g., now). The session will typically have an approximate duration, since the content selected for shared viewing may be paused or rewound, or otherwise delayed prior to playout caused by late joining by audience members, etc.

The records in the Session program table 620 define a many-to-many relationship between sessions and programs to indicate what program will be shared during a session (i.e., watched at each participating station). Each record, identified by its unique SPID, associates the social session with a program via session relationship 621 and a sharing relationship 625. Multiple shared programs will give rise to the creation of multiple records in the session program table 620, one for each program shared during a session, with each subsequent record receiving an incremental sequence number (or in an alternative embodiments, start and stop times).

The Session audience member table 630 tracks the users invited to, or currently participating in, a session. For those currently participating users (i.e., distributed audience members), the Session audience member table 630 will also track the station (e.g., STB) through which the user participates. Each record in the session audience member table 630 has a unique identifier (“SSID”), which associates the session with the user via a session relationship 631. Each record also associates the invited user with the session through an invitee relationship 632. Similarly, each record associates the attending station(s) with the session via an attendee relationship 634. To manage the invitation process, each record in the Session audience member table has a field (the “invite acknowledge field”), which can have a flag set to indicate an invitation acknowledged by a user. Each record typically also has a joined field, which can have a flag set to indicate that a station that successfully joined the session. Alternatively, the currently joined field could reflect whether the stationID field presently has a null value.

One or more users participating in a session (including the owner) can propose one or more advertisements to sponsor the session, with records representing proposed advertisements accumulated in the Session Advertisements table 640. The session relationship 641 will indicate the relationship between each proposed advertisement and the corresponding session. The proposed advertisement relationship 645 defines the relationship between the advertisement and the user who proposed it.

A user might propose a particular advertisement for any number of reasons. For example, a user might propose an advertisement as a reflection of the user's good taste. The user may enjoy the advertisement (e.g., the user finds it entertaining), and/or believes that the other invitees might also consider the advertisement entertaining as well. The user might propose the advertisement because the user wants advice from others regarding the product or service, or simply wants to gauge others' response to it. The user might propose the advertisement because the advertisement fits well with the current program in terms of humor or irony as an example.

The advertising recommendation technique of the present principles can offer additional options beyond merely proposing an advertisement for playout to one or more distributed audience members to sponsor a social television session. For example, the present technique permits finer control to allow advertisements to playout in a show in a user-determined order. In particular, the present invention enables a user to associate specific advertisement breaks with specific intervals within a program (e.g., playout of a particular advertisement early in a movie with playout of another advertisement later within the same the movie). To support such a capability, the records in the session advertisements table 640 could include additional field. For example, a field, hereinafter referred to as sequence number field in the Session Program table 620 can associate each session advertisement record in Session advertisement table 640 with a particular session program record in the Session Program table 620 to indicate the interval in the program during which playout of the desired advertisement would occur.

Still referring to the exemplary embodiment depicted in FIG. 6, upon creation and recording of the social session in the Social session table 610, the owner relationship 614 will then define an association between the user/creator in User table 420′ with the social session. The first audience member for session in Session Participant table 630 typically becomes the session owner. That session owner can then select one or more programs from the Program table 510′ as session programs in the table 620. With the program(s) selected, the session owner can invite one or more additional audience members, to become associated with the session for addition into the table 630.

In some embodiments, the addition of audience members can occur before program selection. Thus, under such circumstances the audience members can vote or otherwise collectively determine the program(s) associated with a given session. Whether other audience members who join the session later can recommend or select program content will depend on the policy of established by operator of the system 100 or a policy established by the session owner. The session owner and the other audience members (depending on the policy in place) can then choose from advertisements already selected by them and noted by records in the User advertisements table 550 of FIG. 5. The chosen advertisement will have an associated record in the Session advertisements table 640 of FIG. 6, with each record in the session advertisement table identified by a unique SAID value and having a relationship with the session defined by session relationship 641 and a relationship with a user proposing the advertisement defined by an advertisement proposer relationship 645. Thus, an advertisement already selected by a user as being of interest to friends at large, becomes the chosen advertisement specifically of interest to the distributed audience members of this session, or apropos to the session program(s), or otherwise a suitable choice.

In some example embodiments, a user choosing an advertisement for inclusion in the Session advertisements table 640 for this social session can designate the advertisement as attributable to that user. In other words, the user who chooses the advertisement will give permission for the telepresence system 100 of FIG. 1 to attribute the choice of that advertisement to him or her upon playout of the advertisement during the session. In some embodiments, attribution can occur automatically or not at all.

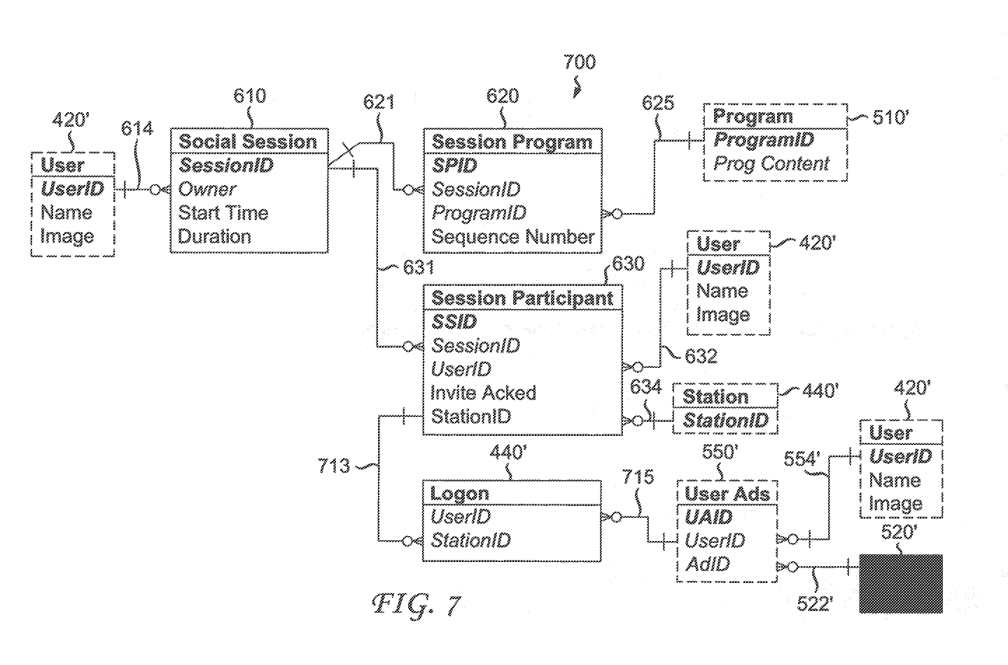

FIG. 7 depicts an alternative exemplary embodiment of the social session portion 700 of the database 106 of FIG. 1. The social session table 610, the session program table 620, and the session audience member table 603 depicted in FIG. 7 typically have the same structure and generally provide the same functionality as the corresponding tables depicted in FIG. 6. The social session portion 700 of the database 106 depicted in FIG. 7 differs from that of FIG. 6 in the following manner. As discussed above with respect to FIG. 6, the session owner and/or audience member(s) explicitly choose advertisements for use in the session, with such chosen advertisements represented in the Session advertisement table 640 of FIG. 6. In contrast, the social session portion 700 of FIG. 7 allows the use of any advertisements previously selected by any user presently logged into a station and participating in the current session. To accomplish such flexibility, the current logon relationship 713 can serve to locate the current logon records from the social session table 610 (i.e., a logon record associated with the indicated station having a null value for the off-time field). The logon records can identify associated user(s) who may or may not comprise invited audience members. The identification of such users, i.e., their userIDs can occur through the selected-advertisements relationship 715. Identifying users logged into stations participating in a particular session enables the identification of the advertisements previously selected by such users as candidate advertisements for sponsoring the present session.

For the Social session portion 700 of the database 106 of FIG. 1 described above with respect to FIG. 7, no one explicitly chooses advertisements, in contrast to the social session portion 700 described with respect to FIG. 6. Thus, the social session portion 700 of FIG. 7 does not individually tag advertisements as attributable to a particular user. In some embodiments (not shown), a user might wish to mark or otherwise designate the selected advertisements as attributable to that user or not, independent of the social session. In other embodiments (not shown), the user could set an overall preference to attribute all of his or her selected advertisements or not. In still other embodiments (not shown), a system policy could determine whether or not session advertisements are attributed.

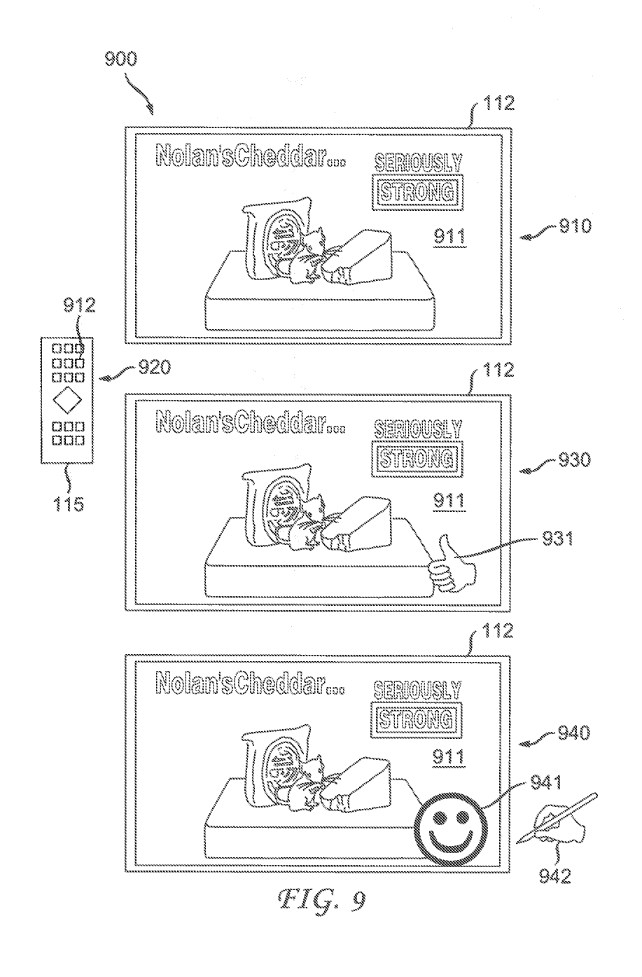

FIG. 8 depicts, in flow chart form, a process 800 for enabling a user to select an advertisement for playout during a social session. The selection process 800 commences upon execution of step 810, during which a user, for example user 113 of FIGS. 1 and 2, tunes his or her STB (e.g., STB 111) to download a particular program from head-end 102 of FIG. 1 for display on the user's content monitor (e.g., the content monitor 112 of FIG. 1). During step 811 of FIG. 8, playout of an advertisement from the head-end 102 begins. Playout of the advertisement triggers the display of an advertisement 911 shown in FIG. 9 as a first step 910 of a storyboard sequence 900 depicted in FIG. 9. Following step 811 of FIG. 8, the STB 111 will monitor for user selection of an advertisement during step 812. The STB tests for selection of an advertisement during step 813. As discussed previously, a user can select an advertisement, such as by pressing a button, e.g., button 913 on the remote control 115 of FIG. 9, or by using another device to signal the STB. Upon determining that advertising playout has ended without selection of an advertisement during step 817, the process 800 ends at step 818.

If the STB detects selection of an advertisement by the user during step 813 of FIG. 8, then during step 815, the STB will trigger creation of a record in the database 106 of FIG. 1. In this example, the STB triggers the creation of a corresponding record in the User advertisements table 550 of FIG. 5. As discussed, the user selects an advertisement by entering an appropriate command through the remote control 115 of FIG. 1. Referring to FIG. 9, the button 912 on the remote control, when actuated by the user during step 920 of the sequence 900, will initiate advertisement selection. Note that the user can initiate selection of an advertisement through other mechanisms besides actuating the remote control 115. Referring to FIG. 9, an acknowledgement of the selection of the advertisement can occur by displaying an icon 931 during the step 930.

Referring to FIG. 8, after step 815, the STB typically generates a status report for display to the user during step 816. Generation of the status report can take the form of displaying an icon 941 (representing “OK”) in FIG. 9 during step 940. Following step 816 of FIG. 8, the STB monitors for commencement of advertisement playout. Upon determining that advertisement playout has ended, the process 800 of FIG. 8 completes during step 818. Upon the immediate playout of another advertisement, then the whole process typically repeats. Otherwise, the next program begins to play.

Providing the user with an acknowledgement and a status report as described above has significant value. A timely acknowledgement and an update will reduce the likelihood that the user would repeatedly press the “select ad” button on remote 115 or take other steps to signal the STB continually, which could lead to uncertainty, confusion, and/or frustration. However, in some circumstances, even though recording of the request for selection in the database during step 815 occurred properly, problems can arise which would prevent indicating the status as “OK.” For example, the advertiser policy for the advertisement associated with the record in Advertisement table 520 of FIG. 5 could indicate that the advertiser will not permit use of the selected advertisement to sponsor a social session. Under such circumstances, the status in table 550 will indicate a status other than “OK.” In such a case, the STB could trigger display of the icon 942 in FIG. 9, along with a message such as “Not currently available,” informally suggesting that a request to the advertiser to allow selection of the advertisement.

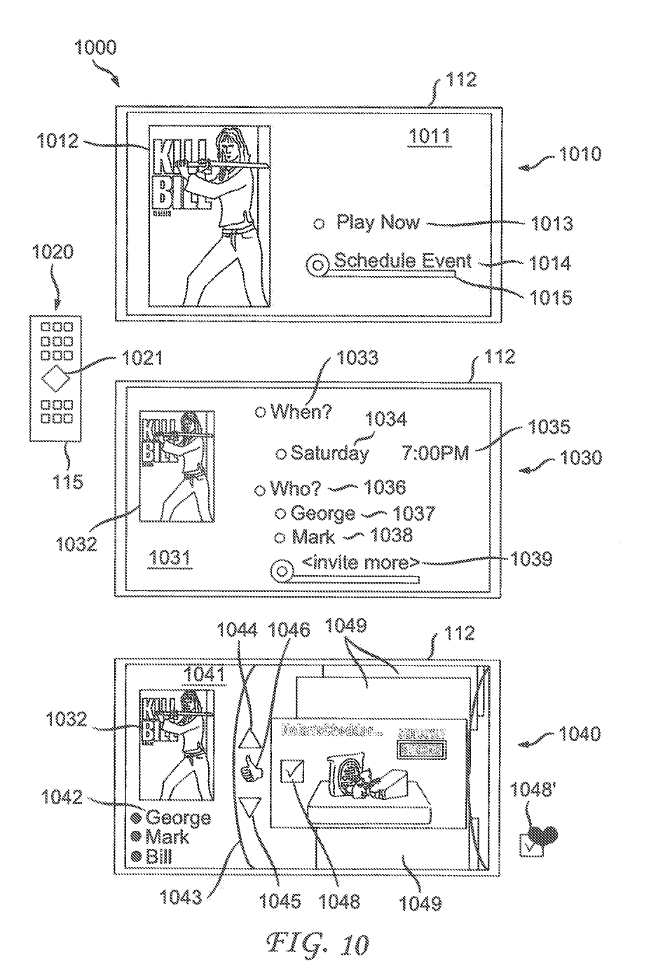

FIG. 10 depicts an example storyboard sequence 1000, which illustrates session creation, program selection, and session advertisement. In particular, the sequence 1000 of FIG. 10 depicts a series of screen shots that a STB, such as STB 111 of FIG. 1, will generate for display to the user (e.g., the audience member 113 of FIG. 1). The sequence 1000 of FIG. 10 commences with step 1010 which when executed by the STB results in the display of the screen 1011 to present the user with a menu to allow the user to browse a program content index using the remote control 115 of FIG. 10. The screen 1011 of FIG. 10 includes an icon 1012 representing the program under consideration. As depicted in FIG. 10, the screen 1011 includes an icon 1013 (“Play Now”) which when activated by the user, will trigger contemporaneous program playout. Further, the screen 1011 can include an icon 1014 (“Schedule Event,”) which when activated by the user, will allow program playout at a later scheduled time.

Assume for purposes of discussion that the user has selected to schedule playout of the program by actuating the selection pad 1021 on the remote control 115 of FIG. 10 during step 1020. In response to such a selection, the STB will trigger the display of an icon 1015, such as the bar appearing beneath the “Schedule Event” icon 1014. The selection made during step 1020 causes the STB 111 of FIGS. 1 and 2 to interact with server 103 of FIG. 1 to create a corresponding record in the Social Session table 610, the Session Programming table 620, and the Session Participant table 630 (all of FIG. 6). Since the user 113 initiated the session, the user 113 becomes the session owner.

Step 1030 follows step 1020 and triggers the display of the screen 1031, which includes an icon 1032, identical to the icon 1012, designating the now-selected session program. The screen 1031 also includes a session start icon 1033 below which appear icons 1034 and 1035 which indicate a particular day and time, respectively. Generally, the start time indicated by the icon 1035 remains flexible. As with a conference call, some distributed audience members might chose to arrive later than others and one or more audience members might choose to wait to join the session until all or most acknowledged audience members have already joined. In some embodiments, playout of the program could occur automatically, with stations joining automatically slightly before the start time, and the entire social session could begin according to the schedule.

Still referring to FIG. 10, the screen 1031 generated during step 1030 includes a list of invitees 1036 that indicates that two users 1037 and 1038 have ready received invitations to join the session. The list of invitees generally starts empty and the user (the session owner) adds invitees by activating the “invite more invitees” icon 1039, which allows the user to invite additional session members. The user could type the names of additional invitees or could select them from a list.

During step 1040, the STB generates screen 1041 for display to the user. The screen includes an advertiser chooser sub-screen 1043, which enables the user to choose advertisements for sponsoring the session as described hereinafter. Note that the program indicator 1032 and audience member list 1042 still appear within the screen 1041 when the advertiser chooser sub-screen 1043 appears during step 1040. The advertisement chooser sub-screen includes a pair of icons 1043 and 1044, which, when actuated, allow the user to scroll forwards and backwards through a collection of advertisements. In the exemplary embodiment of FIG. 10, the advertisement chooser sub-screen depicts advertisement 1047 and 1049 previously selected by the current user, with the advertisement 1047 appearing in the foreground as the advertisement currently under consideration. The advertisement 1047 can appear as a banner or a running version of the advertisement. To select an advertisement, the user will select the icon 1046. Confirmation of the selection of the advertisement occurs via display of the icon 1048. The icons 1044-1046 could constitute corresponding touch pads on a touch pad display. Alternatively, the icons could simply represent passive display indicators, representing actions taken by a user through actuation of a corresponding tough pad on the remote control 115 of FIG. 1.

Upon confirmation of advertisement selection, as indicated by the display of the icon 1048, those embodiments that support user-selected attribution would typically display a further confirmation, via an icon 1048′ to indicate attribution of the selected to the user. As discussed previously, the advertiser, which manages the advertisement selected by the user, might not allow the selected advertisement to sponsor a social session. Under such circumstances, the icon 1048′ would appear without a check mark, indicating the unavailability of that advertisement, not withstanding user selection. Advertisements having a status other than “OK” typically would not appear in the advertisement chooser sub-screen 1043, or if shown, the user cannot choose them.

While the discussion of FIG. 10 has focused on a single user (e.g., the session owner), the session invitees can access a screen similar to screen 1041 to select advertisements.

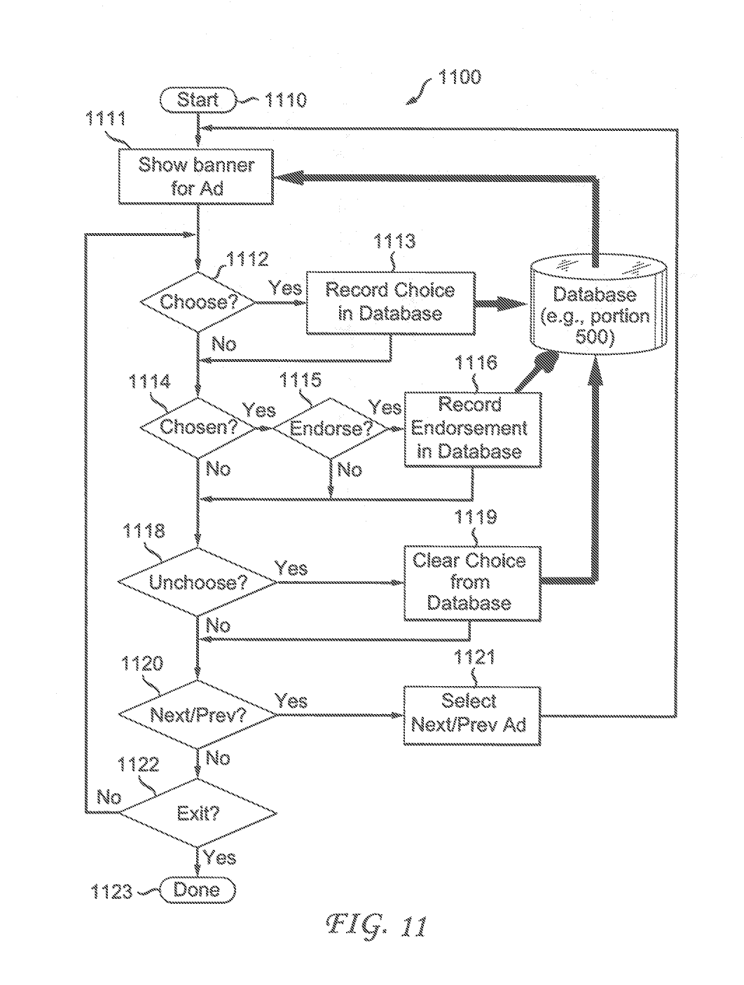

FIG. 11 depicts, in flow chart form, the steps of a process 1100 for choosing one or more advertisements. In the exemplary embodiment of FIG. 11, the process 1100 commences with start step 1110 during which the user's content monitor displays the screen 1041 described previously with respect to FIG. 10. Display of the advertisement 1047 within the advertisement chooser sub-screen 1043 of FIG. 10 occurs during step 1111 of FIG. 11. During step 1112 of FIG. 11, the STB monitors for user advertisement selection. If the STB detects that the user has selected the displayed advertisement during step 1112, the STB notifies the database 106 of FIG. 1 of that choice so the database can record that choice during step 1113 of FIG. 11. Typically, the database 106 records the advertisement choice by creating a corresponding record in the Session advertisements table 640 of FIG. 6. In embodiments that support user-elected attribution, then the step 1115 of FIG. 11 undergoes execution to determine whether the user seeks to endorse the advertisement for attribution to him or her. If the user wishes to endorse the selected advertisement, the step 1116 undergoes execution to record the endorsement in the database 106 of FIG. 1, by setting the attribution flag in the table 640 of FIG. 6.

Following steps 1114 or 1115 for a “no” condition, or step 1116 after recording of the endorsement, then step 1118 undergoes execution to determine whether the user has changed his or her mind and now wishes to “unchoose” a previously chosen advertisement. If the user has decided to deselect the previously selected advertisement, then step 1119 undergoes execution to clear the previously recorded advertisement choice in the database 106 of FIG. 1, and particularly, to remove the corresponding record from session advertisement table 640 of FIG. 6.

Following the “no” path of step 1118, or the execution of step 1119, then step 1120 undergoes execution to check whether the user has advanced to a new advertisement for possible selection or returned to a previous advertisement for de-selection. If so, the step 1121 undergoes execution for selection of the next or previous advertisement prior to returning to re-execution of step 1111. Otherwise, following the “no” branch of step 1120, the STB monitors for an indication that the user wishes to exit the process. If so, the process ends at step 1123. Otherwise, the process 1100 of FIG. 11 branches back to step 1112.

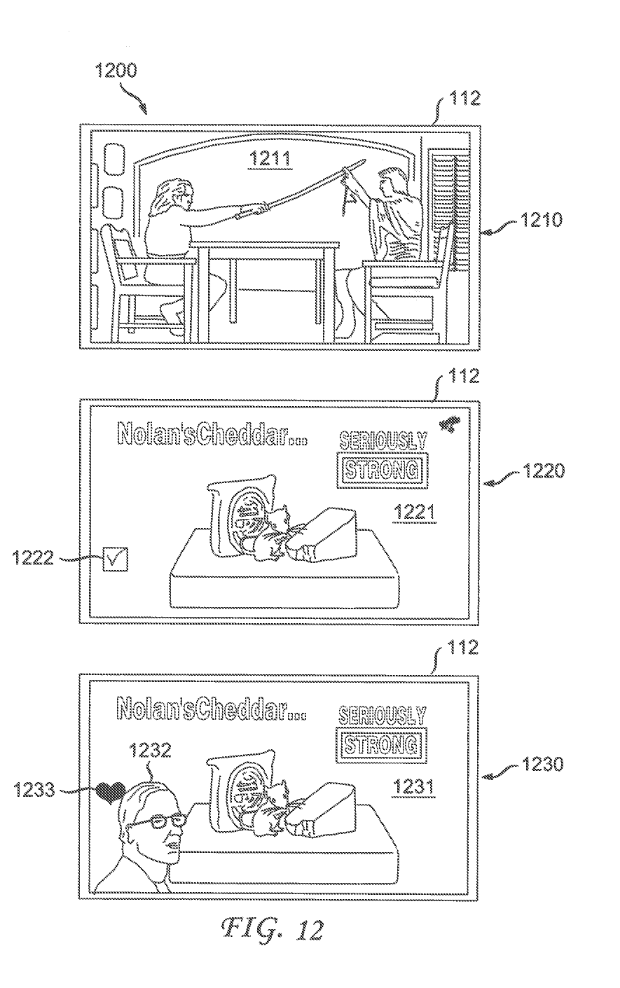

FIG. 12 shows a storyboard sequence 1200 of an ongoing social session. Step 1210 of the sequence 1200 depicts a display screen 1211 on which appears a feature presentation, corresponding to the selected program 1012 of FIG. 10. The content store 104 of FIG. 1 streams the selected feature presentation to each of the STBs 111, 121, 131, 141 of FIG. 1 for display on corresponding shared content monitors 112, 122, 132, 142, respectively, of FIG. 1, assuming that the owner at site 110 and all three invitees at sites 120, 130, and 140 of FIG. 1 have joined the social session. Step 1220 of FIG. 12 depicts a display screen 1221 on which appears a predetermined advertisement during a break in the feature program. In other words, playout of the program content 1211 pauses, replaced by playout of the advertisement 1221 streamed from the database 105 for display on each of the shared content displays at the participating sites. An icon 1222 in the form of a check box can appear within the screen 1221 of FIG. 12 to indicate that this advertisement was chosen by one or more of the audience members in the current social session, which might prompt questions or guessing as to who chose this advertisement and why. Rather than display icon 1222 appearing as a check box, the icon could take the form of a counter to indicate explicitly how many of the audience members in the current social session had chosen this advertisement.

In an exemplary embodiment, the STB could generate the screen 1231 for display during step 1230. As depicted in FIG. 12, the screen 1231 includes an icon 1233 to indicate attribution. Further, the screen 1231 can include the name (not shown) of the person(s) who endorsed the advertisement and the image 1232 (displayed as an overlay) of the audience member(s) who chose the advertisement for this social session. The image 1232 can take the form of a stored record retrieved from the appropriate user record in the user table 420 of FIG. 4. Alternatively, the image can represent a live video feed from a telepresence system, e.g., from telepresence camera 117 (assuming that audience member 113 chose this advertisement.) Other advertisements, not chosen according to the present principles, can play out, but without the “chosen” icon 1222, or attribution icon 1233 or user image 1232.

The foregoing describes a telepresence system that can improve advertising among a plurality of distributed audience members by allowing members to choose appropriate advertisements for reasons of their own, if advertisers permit such choices. The telepresence system of the present principles does not require pre-selection, advanced scheduling, or content or pre-selection of the advertisements, as described with respect to FIG. 10. Instead, the content could comprise a live event, such as a football game or the like, with friends dynamically creating a social session or joining one already in progress associated with this event. Under such circumstances, the session owner could make use of the social session portion 700 of database 106 shown in FIG. 7 to select one or more advertisements from among the user advertisements corresponding to users currently logged into stations currently participating in the social session. Attribution to the selected advertisement will depend on existing policy or the session owner's choice.

Those skilled in the art will recognize that the relational database implementations shown in FIGS. 4-7 represent exemplary choices and that other choices for data configuration, including a different normalization or selection of non-relational data representations, exist which fall within the scope of the present principles. Further, that the user interface hardware (e.g., the remote control 115 and its buttons) and methods described herein, represent merely one an example of other techniques available for entering user commands. For example, a variety of other mechanisms, such as a voice command system, a gesture recognition system, a touch screen, a keyboard and/or & mouse, for example could serve to enter user commands to an STB.

Further, the screen displays represent exemplary depictions of what would appear on the content display and telepresence monitors but many other possible screen displays could occur without departing from the present principles.

1. A method for selecting content by one member of an audience for playout to at least one other member of that audience, comprising the steps of:
establishing a content recommendation from the one audience member based on the one audience member's interaction with the at least one piece of content; and
transmitting the content recommended by the one audience member to the at least one other member.

2. The method according to claim 1 wherein the at least one piece of content is an advertisement.

3. The method according to claim 1 wherein the content recommendation is established based on a receipt of a user-entered content recommendation.

4. The method according to claim 3 further including the step of acknowledging receipt of user-entered content recommendation.

5. The method according to claim 4 wherein the step of acknowledging receipt of user-entered content recommendation comprises the step of displaying an acknowledgement indication to the user.

6. The method according to claim 1 wherein the content recommendation is established based on a user's viewing at least a prescribed portion of the content a second time.

7. The method according to claim 1 wherein the step of establishing a content recommendation from a user includes the steps of:
determining whether a content provider providing the recommended content authorizes transmission of the recommended content to the at least one distributed audience member for playout, and if not
preventing transmission of the recommended content to the at least one member.

8. The method according to claim 7 further including the step of alerting the user of prevention of the transmission of the recommended content to the at least one member.

9. The method according to claim 1 further including the step of receiving from a user an identification of audience members destined to receive the recommended content and wherein the transmitting step includes the step of transmitting the content to the audiences members identified by the user member for playout along with an attribution of the user.

10. The method according to claim 1 wherein the attribution of the user comprises the user's name.

11. The method according to claim 1 wherein the attribution comprises the user's image.

12. A method for selecting content by a user for playout to members of distributed audience during a social television session, comprising the steps of:
establishing the social television session by inviting selected recipients to join the join the social television session in accordance with a user-received identification of the selected recipients;
establishing a content recommendation from a user recommending at least one piece of content user based on the user's interaction with said content;
playing out the content identified by the content recommendation to the selected recipients who have joined the social television session.

13. The method according to claim 12 further including the steps of:
determining whether to attribute the content recommendation to the user; and
transmitting the attribution of the user upon a determination to attribute the content recommendation to the user.

14. The method according to claim 12 wherein the at least one piece of content is an advertisement.

15. The method according to claim 12 wherein the content recommendation is established based on a receipt of a user-entered content recommendation.

16. The method according to claim 15 further including the step of acknowledging receipt of user-entered content recommendation.

17. The method according to claim 16 wherein the step of acknowledging receipt of user-entered content recommendation comprises the step of displaying an acknowledgement indication to the user.

18. The method according to claim 12 wherein the content recommendation is established based on a user's viewing at least a prescribed portion of the content a second time.

19. The method according to claim 12 wherein the step of establishing a content recommendation from a user includes the steps of:
determining whether a content provider providing the recommended content authorizes transmission of the recommended content to the at least one distributed audience member for playout, and if not
preventing transmission of the recommended content to the at least one member.

20. The method according to claim 19 further including the step of alerting the user of prevention of the transmission of the recommended content to the at least one member
